(19) United States
(12) Patent Application Publication
(10) Pub. No.: US 2022/0126546 A1
(43) Pub. Date: Apr. 28, 2022

(54) POLYMER FILM HAVING LAMINATED STRUCTURE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Jhen-Rong Syu, TAIPEI (TW)

(21) Appl. No.: 17/380,020

(22) Filed: Jul. 20, 2021

(30) Foreign Application Priority Data
Oct. 26, 2020 (TW) 109137038

(51) Int. Cl. B32B 7/023; B32B 27/08; B32B 27/36; B32B 27/30; B44F 1/14

(52) U.S. Cl. CPC B32B 7/023; B32B 27/08; B32B 27/36; B32B 27/30; B32B 2307/409; B32B 2307/416; B32B 2307/732; B32B 2451/00; B44F 1/14

(57) ABSTRACT

A polymer film having a laminated structure is provided. The polymer film includes a plurality of first overlapping film units and a plurality of second overlapping film units disposed in an alternately-laminated manner with the first overlapping film units. Each of the first overlapping film units includes a first lower film and a first upper film, and each of the first overlapping film units is configured to reflect visible light in a first visible light wavelength range. Each of the second overlapping film units includes a second lower film and a second upper film, and each of the second overlapping film units is configured to reflect visible light in a second visible light wavelength range. The first visible light wavelength range is different from the second visible light wavelength range.

### CROSS-REFERENCE TO RELATED PATENT APPLICATION

This application claims the benefit of priority to Taiwan Patent Application No. 109137038, filed on Oct. 26, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polymer film, and more particularly to a polymer film having a laminated structure, which is configured to provide a rainbow-like visual effect.

### BACKGROUND OF THE DISCLOSURE

Generally, a rainbow film is a polymer film having a laminated structure (otherwise referred to as a laminated film). The rainbow film is the polymer film configured to naturally show a visual effect of a rainbow, without any dyes or coloring materials added. The rainbow film, which has a dazzling gloss, is a product for decorative purposes.

A conventional rainbow film is made of at least two transparent thermoplastic polymer films having different refractive indexes. In terms of a laminated configuration, a lamination of the rainbow film is disposed in the order of A/B/A/B/A/B or A/B/C/A/B/C/A/B/C. A, B, and C respectively represent different polymer resin material films.

When a thickness of the lamination of the film reaches a certain value, the polymer film reflects light having a certain wavelength due to an interference effect of lights. Furthermore, the polymer film is configured to further generate a colorful visual effect of a rainbow-like pattern by a design of different laminated-thickness of the lamination of the film.

In the design of the above-mentioned rainbow film, a choice of polymer resins having different refractive indexes and a design of the laminated structure of the polymer film are essential to the manufacturing of the rainbow film. According to currently published patent documents, conventional polymer resins are usually selected from EVA/PS, PMMA/PET, PMMA/PBT, PMMA/PETG, and PMMA/POL. Furthermore, the laminated structure of the polymer film is mostly designed to have an increasing thickness. For example, a thickness of the polymer film disposed in the order of A/B/A/B/A/B gradually increases from 100 nanometers/150 nanometers to 150 nanometers/200 nanometers. During a manufacturing process of the polymer film designed to have the increasing thickness, an issue relating to difficulty in controlling the thickness is likely to occur, and a yield of such product is therefore poor.

### SUMMARY OF THE DISCLOSURE

In response to the above-referenced technical inadequacy, the present disclosure provides a polymer film having a laminated structure, which is configured to provide a rainbow-like visual effect.

In one aspect, the present disclosure provides a polymer film having the laminated structure. The polymer film includes a plurality of first overlapping film units and a plurality of second overlapping film units disposed in an alternately-laminated manner with the first overlapping film units. Each of the first overlapping film units includes a first lower film and a first upper film, and each of the first overlapping film units is configured to reflect visible light in a first visible light wavelength range by cooperation of the first lower film and the first upper film. Each of the second overlapping film units includes a second lower film and a second upper film, and each of the second overlapping film units is configured to reflect visible light in a second visible light wavelength range by cooperation of the second lower film and the second upper film. The first visible light wavelength range is different from the second visible light wavelength range.

In certain embodiments, an optical characteristic parameter of each of the first overlapping film units is different from a corresponding optical characteristic parameter of each of the second overlapping film units. The optical characteristic parameter is at least one of a refractive index, a reflectance, and a transmittance.

In certain embodiments, in the polymer film, a thickness of each of the first lower films, a thickness of each of the first upper films, a thickness of each of the second lower films, and a thickness of each of the second upper films are within a range from 10 nanometers to 200 nanometers.

In certain embodiments, in the first overlapping film units, a thickness error between any two of the first lower films is less than or equal to 10%, and a thickness error between any two of the first upper films is less than or equal to 10%. In the second overlapping film units, a thickness error between any two of the second lower films is less than or equal to 10%, and a thickness error between any two of the second upper films is less than or equal to 10%.

In certain embodiments, in the polymer film, a sum of a number of laminations of the first lower films, a number of laminations of the first upper films, a number of laminations of the second lower films, and a number of laminations of the second upper films is within a range from 40 to 800.

In certain embodiments, when light is emitted to the polymer film, the light is configured to be reflected and interfered for multiple times at a plurality of interfaces between different films in the polymer film, so as to generate at least two reflected lights corresponding to at least two wavelengths.

In certain embodiments, in each of the first overlapping film units, the first lower film is one of a first acrylate copolymer film and a first polyester copolymer film, and the first upper film is another one of the first acrylate copolymer film and the first polyester copolymer film.

In certain embodiments, in each of the second overlapping film units, the second lower film is one of a second acrylate copolymer film and a second polyester copolymer film, and the second upper film is another one of the second acrylate copolymer film and the second polyester copolymer film.

In certain embodiments, an optical characteristic parameter of the first polyester copolymer film is different from a corresponding optical characteristic parameter of the second polyester copolymer film, or an optical characteristic parameter of the first acrylate copolymer film is different from a corresponding optical characteristic parameter of the second acrylate copolymer film, so that an optical characteristic parameter of each of the first overlapping film units is different from a corresponding optical characteristic parameter of each of the second overlapping film units.

In certain embodiments, the first visible light wavelength range is within a range from 380 nanometers to 500 nanometers, and the second visible light wavelength range is within a range from 500 nanometers to 740 nanometers.

Therefore, in the polymer film having the laminated structure provided by the present disclosure, by virtue of “the polymer film including a plurality of first overlapping film units and a plurality of second overlapping film units disposed in an alternately-laminated manner with the first overlapping film units, each of the first overlapping film units including a first lower film and a first upper film, each of the first overlapping film units being configured to reflect visible light in a first visible light wavelength range by cooperation of the first lower film and the first upper film, each of the second overlapping film units including a second lower film and a second upper film, each of the second overlapping film units being configured to reflect visible light in a second visible light wavelength range by cooperation of the second lower film and the second upper film, and the first visible light wavelength range being different from the second visible light wavelength range”, the polymer film has advantages of easy processing and low manufacturing cost.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a side view of a polymer film having a laminated structure according to an embodiment of the present disclosure; and

FIG. 2 is a partially enlarged view of section II of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A technical inadequacy mentioned in the background of the present disclosure is that, in the conventional rainbow films, a laminated structure of a polymer film is mostly designed to have an increasing thickness. During a manufacturing process of the polymer film designed to have the increasing thickness, an issue relating to difficulty in controlling the thickness is likely to occur, and a yield of such product is therefore poor.

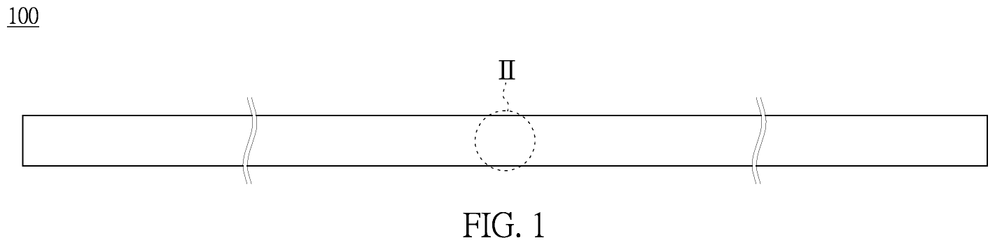

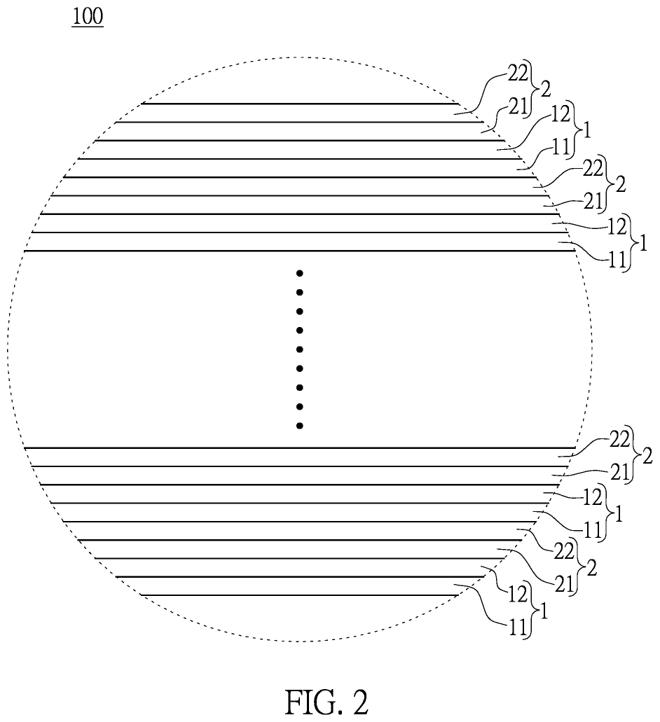

Referring to FIG. 1 to FIG. 2, in order to improve the above-mentioned technical inadequacy, an embodiment of the present disclosure provides a polymer film 100 with a laminated structure. The polymer film 100 is configured to provide a rainbow-like visual effect, and the polymer film 100 has advantages of easy processing and low manufacturing cost by a special design of the laminated structure of the polymer film.

Specifically, the polymer film 100 with the laminated structure is a rainbow film, and includes a plurality of first overlapping film units 1 and a plurality of second overlapping film units 2. The second overlapping film units 2 are disposed in an alternately-laminated manner with the first overlapping film units 1.

More specifically, each of the first overlapping film units 1 includes a first lower film 11 and a first upper film 12, and the first upper film 12 is formed above the first lower film 11. Each of the first overlapping film units 1 is configured to reflect visible light in a first visible light wavelength range by cooperation of the first lower film 11 and the first upper film 12, so as to produce reflected light having a first color.

Furthermore, each of the second overlapping film units 2 includes a second lower film 21 and a second upper film 22, and the second upper film 22 is formed above the second lower film 21. Each of the second overlapping film units 2 is configured to reflect visible light in a second visible light wavelength range by cooperation of the second lower film 21 and the second upper film 22, so as to produce reflected light having a second color. The first visible light wavelength range is different from the second visible light wavelength range. In other words, the reflected light having the first color is different from the reflected light having the second color, and the reflected lights having different colors are configured to be interfered by each other, so as to produce a plurality of dazzling glosses.

As shown in FIG. 2, in the present embodiment, the plurality of first overlapping film units 1 and the plurality of second overlapping film units 2 are laminated in the order of the first overlapping film unit 1/the second overlapping film unit 2/the first overlapping film unit 1/the second overlapping film unit 2/the first overlapping film unit 1/the second overlapping film unit 2/ . . . /the first overlapping film unit 1/the second overlapping film unit 2 from bottom to top of the polymer film 100, but the present disclosure is not limited thereto.

Specifically, in the present embodiment, the plurality of first overlapping film units 1 and the plurality of second overlapping film units 2 are laminated in the order of the first lower film 11/the first upper film 12/the second lower film 21/the second upper film 22/the first lower film 11/the first upper film 12/the second lower film 21/the second upper film 22/ . . . /the first lower film 11/the first upper film 12/the second lower film 21/the second upper film 22 from bottom to top of the polymer film 100, but the present disclosure is not limited thereto.

Preferably, an optical characteristic parameter of the first overlapping film unit 1 is different from a corresponding optical characteristic parameter of the second overlapping film unit 2, so that the polymer film 100 in the present embodiment is configured to reflect at least two reflected lights corresponding to at least two wavelengths. The optical characteristic parameter can be, for example, at least one of a refractive index, a reflectance, and a transmittance.

Specifically, in the present embodiment, an optical characteristic parameter of the first lower film 11 is different from a corresponding optical characteristic parameter of the second lower film 21. Or, an optical characteristic parameter of the first upper film 12 is different from a corresponding optical characteristic parameter of the second upper film 22. Accordingly, the optical characteristic parameter of each of the first overlapping film units 1 is different from the corresponding optical characteristic parameter of each of the second overlapping film units 2.

There are a number of ways for the optical characteristic parameters of the different overlapping film units to be different, such as, but not limited to, the following: choosing different polymer resin materials for the different overlapping film units; choosing the same polymer resin material, but each of the different overlapping film units having different molecular weights, densities, or degrees of polymerization; or choosing the same polymer resin material, but the different overlapping film units having different monomers of copolymers (for instance: two polyester copolymer films have different monomers of copolymers).

According to the design of the laminated structure of the polymer film 100 of the present embodiment, each of the overlapping film units is designed to have substantially the same thickness, instead of an increasing thickness, so that the polymer film 100 has advantages of easy processing and low manufacturing cost.

In terms of the thickness of each of the overlapping film units, in the polymer film 100, a thickness of the first lower films 11, a thickness of the first upper films 12, a thickness of the second lower films 21, and a thickness of the second upper films 22 are within a range from 10 nanometers to 200 nanometers, and preferably within a range from 30 nanometers to 150 nanometers, but the present disclosure is not limited thereto.

More specifically, in the first overlapping film units 1, a thickness error between any two of the first lower films 11 is usually less than or equal to 10%. Preferably, the thickness error between any two of the first lower films 11 is less than or equal to 5%, and more preferably, the thickness error between any two of the first lower films 11 is less than or equal to 2%. A thickness error between any two of the first upper films 12 is usually less than or equal to 10%. Preferably, the thickness error between any two of the first upper films 12 is less than or equal to 5%, and more preferably, the thickness error between any two of the first upper films 12 is less than or equal to 2%.

Furthermore, in the second overlapping film units 2, a thickness error between any two of the second lower films 21 is usually less than or equal to 10%. Preferably, the thickness error between any two of the second lower films 21 is less than or equal to 5%, and more preferably, the thickness error between any two of the second lower films 21 is less than or equal to 2%. A thickness error between any two of the second upper films 22 is usually less than or equal to 10%. Preferably, the thickness error between any two of the second upper films 22 is less than or equal to 5%, and more preferably, the thickness error between any two of the second upper films 22 is less than or equal to 2%.

In terms of a number of laminations of the polymer film 100, a sum of a number of laminations of the first lower films 11, a number of laminations of the first upper films 12, a number of laminations of the second lower films 21, and a number of laminations of the second upper films 22 is usually within a range from 40 to 800, is preferably within a range from 80 to 700, and is more preferably within a range from 120 to 600, but the present disclosure is not limited thereto.

According to the above configuration, when light is emitted to the polymer film 100, the light is configured to be reflected and interfered for multiple times at a plurality of interfaces between different films in the polymer film 100, so as to generate at least two reflected lights corresponding to at least two wavelengths. In addition, the at least two reflected lights corresponding to the at least two wavelengths have wavelength ranges that correspond to the first visible light wavelength range and the second visible light wavelength range, respectively. In this way, the polymer film 100 is configured to generate the rainbow-like visual effect and dazzling glosses.

In an exemplary embodiment of the present disclosure, each of overlapping film units has a preferable material choice. Specifically, in each of the first overlapping film units 1, the first lower film 11 is one of a first acrylate copolymer film and a first polyester copolymer film, and the first upper film 12 is another one of the first acrylate copolymer film and the first polyester copolymer film. For example, the first lower film 11 is the first acrylate copolymer film, and the first upper film 12 is the first polyester copolymer film, but the present disclosure is not limited thereto.

In each of the second overlapping film units 2, the second lower film 21 is one of a second acrylate copolymer film and a second polyester copolymer film, and the second upper film 22 is another one of the second acrylate copolymer film and the second polyester copolymer film. For example, the second lower film 21 is the second acrylate copolymer film, and the second upper film 22 is the second polyester copolymer film, but the present disclosure is not limited thereto.

Furthermore, an optical characteristic parameter of the first polyester copolymer film is different from a corresponding optical characteristic parameter of the second polyester copolymer film. Or, an optical characteristic parameter of the first acrylate copolymer film is different from a corresponding optical characteristic parameter of the second acrylate copolymer film. Accordingly, the optical characteristic parameter of each of the first overlapping film units 1 is different from the corresponding optical characteristic parameter of each of the second overlapping film units 2.

In an exemplary embodiment of the present disclosure, the first polyester copolymer film and the second polyester copolymer film, for example, have different molecular weights, densities, or degrees of polymerization, so that the optical characteristic parameter of the first polyester copolymer film is different from the corresponding optical characteristic parameter of the second polyester copolymer film.

In another exemplary embodiment of the present disclosure, the first polyester copolymer film and the second polyester copolymer film, for example, have different monomers of copolymers, so that the optical characteristic parameter of the first polyester copolymer film is different from the corresponding optical characteristic parameter of the second polyester copolymer film.

According to the configuration, the first visible light wavelength range is within a range from 380 nanometers to 500 nanometers, and the second visible light wavelength range is within a range from 500 nanometers to 740 nanometers.

It is worth mentioning that, in the present embodiment, the polymer film 100 with the laminated structure is preferably generated by way of co-extrusion, but the present disclosure is not limited thereto.

### BENEFICIAL EFFECT OF THE EMBODIMENTS

In conclusion, in the polymer film having the laminated structure provided by the present disclosure, by virtue of “the polymer film including a plurality of first overlapping film units and a plurality of second overlapping film units and a plurality of second overlapping film units disposed in an alternately-laminated manner with the first overlapping film units, each of the first overlapping film units including a first lower film and a first upper film, each of the first overlapping film units being configured to reflect visible light in a first visible light wavelength range by cooperation of the first lower film and the first upper film, each of the second overlapping film units including a second lower film and a second upper film, each of the second overlapping film units being configured to reflect visible light in a second visible light wavelength range by cooperation of the second lower film and the second upper film, and the first visible light wavelength range being different from the second visible light wavelength range”, the polymer film has advantages of easy processing and low manufacturing cost.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polymer film having a laminated structure, comprising:
a plurality of first overlapping film units each including a first lower film and a first upper film, wherein each of the first overlapping film units is configured to reflect visible light in a first visible light wavelength range by cooperation of the first lower film and the first upper film; and
a plurality of second overlapping film units disposed in an alternately-laminated manner with the first overlapping film units, wherein each of the second overlapping film units includes a second lower film and a second upper film, and each of the second overlapping film units is configured to reflect visible light in a second visible light wavelength range by cooperation of the second lower film and the second upper film, and wherein the first visible light wavelength range is different from the second visible light wavelength range.

2. The polymer film according to claim 1, wherein an optical characteristic parameter of each of the first overlapping film units is different from a corresponding optical characteristic parameter of each of the second overlapping film units, and wherein the optical characteristic parameter is at least one of a refractive index, a reflectance, and a transmittance.

3. The polymer film according to claim 2, wherein, in the polymer film, a thickness of each of the first lower films, a thickness of each of the first upper films, a thickness of each of the second lower films, and a thickness of each of the second upper films are within a range from 10 nanometers to 200 nanometers.

4. The polymer film according to claim 3, wherein, in the first overlapping film units, a thickness error between any two of the first lower films is less than or equal to 10%, and a thickness error between any two of the first upper films is less than or equal to 10%, and wherein, in the second overlapping film units, a thickness error between any two of the second lower films is less than or equal to 10%, and a thickness error between any two of the second upper films is less than or equal to 10%.

5. The polymer film according to claim 4, wherein, in the polymer film, a sum of a number of laminations of the first lower films, a number of laminations of the first upper films, a number of laminations of the second lower films, and a number of laminations of the second upper films is within a range from 40 to 800.

6. The polymer film according to claim 1, wherein, when light is emitted to the polymer film, the light is configured to be reflected and interfered for multiple times at a plurality of interfaces between different films in the polymer film, so as to generate at least two reflected lights corresponding to at least two wavelengths.

7. The polymer film according to claim 6, wherein, in each of the first overlapping film units, the first lower film is one of a first acrylate copolymer film and a first polyester copolymer film, and the first upper film is another one of the first acrylate copolymer film and the first polyester copolymer film.

8. The polymer film according to claim 7, wherein, in each of the second overlapping film units, the second lower film is one of a second acrylate copolymer film and a second polyester copolymer film, and the second upper film is another one of the second acrylate copolymer film and the second polyester copolymer film.

9. The polymer film according to claim 8, wherein an optical characteristic parameter of the first polyester copolymer film is different from a corresponding optical characteristic parameter of the second polyester copolymer film, or an optical characteristic parameter of the first acrylate copolymer film is different from a corresponding optical characteristic parameter of the second acrylate copolymer film, so that an optical characteristic parameter of each of the first overlapping film units is different from a corresponding optical characteristic parameter of each of the second overlapping film units.

10. The polymer film according to claim 9, wherein the first visible light wavelength range is within a range from 380 nanometers to 500 nanometers, and the second visible light wavelength range is within a range from 500 nanometers to 740 nanometers.
